(19) United States
(12) Patent Application Publication
(10) Pub. No.: US 2019/0040780 A1
(43) Pub. Date: Feb. 7, 2019

(54) VARIABLE GEOMETRY DEF MIXER DESIGN

(71) Applicant: International Engine Intellectual Property Company, LLC, Lisle, IL (US)

(72) Inventors: Bradley Jay Adelman, Chicago, IL (US); Seth Ulrich Brenneman, San Antonio, TX (US)

(73) Assignee: International Engine Intellectual Property Company, LLC, Lisle, IL (US)

(21) Appl. No.: 15/883,380

(22) Filed: Jan. 30, 2018

Related U.S. Application Data
(60) Provisional application No. 62/336,247, filed on May 13, 2016.

(51) Int. Cl. F01N 3/28; F01N 3/20; B01F 5/06

(52) U.S. Cl. CPC F01N 3/2892; F01N 3/208; B01F 2005/0622; F01N 2240/20; B01F 5/0611

(57) ABSTRACT

A variable geometry mixer for mixing reductant with engine exhaust includes at least one movable mixer blade or set of movable vanes. The variable geometry mixer is operable to extend the mixer blade(s) into the flow of exhaust under low exhaust flow conditions and to retract the mixer blade(s) out of the flow of exhaust under high exhaust flow conditions, or to increase the angle of the movable vanes under low exhaust flow conditions and to decrease the angle of the movable vanes under high exhaust flow conditions. The movable mixer blade(s) may adjoin at least one fixed geometry defining component. Control of the angle or position of the mixer blade(s) or movable vanes may be based on exhaust flow conditions, exhaust temperature, reductant dosing quantity, a particulate filter regeneration event, vehicle information, vehicle engine information, vehicle location, topographical information, and/or environmental information.

### BACKGROUND

### Field of Invention

Embodiments described herein generally relate to a mixer for causing a reductant such as urea to more completely evaporate in an engine exhaust flow by generating swirling exhaust gas flow under low exhaust flow conditions, while minimizing flow restriction under high exhaust flow conditions.

### Related Art

Diesel engines commonly operate with a lean air to fuel ratio, so that only part of the available oxygen is used in the fuel combustion reaction. While this helps to make diesel engines efficient, it also results in the formation of nitrogen oxides (NOx), an undesirable pollutant, during the combustion process. Presently, the Environmental Protection Agency (EPA) regulates the amount of NOx that may be emitted in vehicle exhaust, so that vehicle and engine manufacturers employ various techniques to reduce NOx emissions.

A common technique to reduce NOx tailpipe emissions involves the use of Selective Catalytic Reduction (SCR). SCR works by injecting a solution of urea, a reductant that is sometimes referred to as Diesel Exhaust Fluid (DEF), into the flow of vehicle engine exhaust. Such DEF is commonly sold under the trademark AdBlue, or as ISO 22241 AUS325. The urea solution then evaporates and thermally decomposes due to the heat of the exhaust. Ammonia liberated from the urea then reacts with the NOx in the presence of a catalyst to form diatomic nitrogen (N2), water (H2O), and carbon dioxide (CO2). The catalyst is provided in the form of a structure, often a honeycomb shape or similar arrangement, with a coating such as a metal oxide or metal exchanged zeolites, located downstream in the exhaust flow from the location of urea injection. The SCR urea injector and catalytic device, together with a filter for removing particulates from the exhaust flow, generally located upstream in the exhaust flow from the SCR urea injector and catalytic device, are often collectively referred to as exhaust after-treatment.

In order to maximize the effectiveness of the catalytic device, the evaporated urea and its thermal decomposition products, including the ammonia, must be properly mixed with the vehicle engine exhaust before entering the catalytic device. This requires either a very long mixing pipe between the SCR urea injector and the catalytic device, or the use of a mixing device. Such mixing devices may be designed to improve the uniformity index of the distribution of the urea reductant and ammonia in the exhaust gas flow. However, in order to achieve a high conversion rate of DEF to ammonia, as well as to achieve a high uniformity index, the mixer design needs to be tuned to the exhaust flow conditions and to the desired quantity of DEF to be injected. Unfortunately, an optimal mixer design based on conditions of low exhaust flow may not be an optimal mixer design for conditions of high exhaust flow. Known mixer designs use fixed geometry, such that the mixer design selected is often a compromise mixer design that provides moderately good performance over a range of engine exhaust gas flow conditions.

Accordingly, there is an unmet need for an apparatus and method for properly mixing reductant with vehicle engine exhaust without requiring a very long mixing pipe between the SCR urea injector and the catalytic device, such that proper mixing takes place over a full range of exhaust flow conditions.

### SUMMARY

Embodiments described herein relate to a Variable Geometry DEF Mixer for properly mixing reductant with vehicle engine exhaust over a full range of exhaust flow conditions. The Variable Geometry DEF Mixer may be applied to various types of engine exhaust aftertreatment systems, including those used in light, medium, and heavy-duty vehicles. The Variable Geometry DEF Mixer may further be applied to engine exhaust aftertreatment systems used in numerous possible applications, including vehicular, stationary, and marine, as non-limiting examples. The several embodiments presented herein use movable geometry defining components in the form of mixer blades or movable vanes within the Variable Geometry DEF Mixer as examples, but this is not to be construed as limiting the scope of the Variable Geometry DEF Mixer design.

The use of a Variable Geometry DEF Mixer, such as one using movable geometry defining components such as movable mixer blades or movable vanes that may be adjusted based, for example, upon engine exhaust flow conditions, allows for optimal reductant and exhaust mixing performance over all or at least a much larger proportion of exhaust gas flow conditions that may be experienced under real-world drive or operating cycles. The movable geometry defining components are mechanically adjusted by way of a change in angle and/or position, so that optimal mixing is achieved based, for example, on exhaust flow, temperature, and reductant dosing quantity. At least one actuator actuates the mechanical adjustment, and may be pneumatic, electric, or hydraulic in nature, as non-limiting examples. Mechanical adjustment of the movable geometry defining components may further depend upon other factors, such as a current, pending, or recent particulate filter regeneration event, or other engine, vehicle, location, topographical, or environmental information.

More specifically, embodiments of the Variable Geometry DEF Mixer utilizing at least one movable mixer blade use at least one actuator to increase or decrease the angle of the at least one mixer blade within the mixer device, thereby extending the at least one mixer blade further into the exhaust flow or retracting the at least one mixer blade further out of the exhaust flow, respectively. Further embodiments of the Variable Geometry DEF Mixer utilizing at least one movable mixer blade may extend the at least one mixer blade further into the exhaust flow under conditions of low exhaust flow, resulting in increased swirl and rotation of the exhaust flow, thereby improving breakup of reductant droplets and mixing of the reductant with the exhaust. Such conditions of low exhaust flow may be encountered when the engine to which the engine exhaust aftertreatment system is connected is operating at a low power and/or speed, for example in the lower half of the engine's power and/or speed operating range. Further embodiments of the Variable Geometry DEF Mixer utilizing at least one movable mixer blade may retract the at least one mixer blade out of the exhaust flow under conditions of high exhaust flow, resulting in decreased swirl and rotation of the exhaust flow, but also reducing exhaust flow restriction. Such conditions of high exhaust flow may be encountered when the engine to which the engine exhaust aftertreatment system is connected is operating at a high power and/or speed, for example in the upper half of the engine's power and/or speed operating range.

Similarly, embodiments of the Variable Geometry DEF Mixer utilizing at least one set of movable vanes use at least one actuator to increase or decrease the angle of the at least one set of movable vanes within the mixer device, thereby skewing the at least one set of movable vanes with respect to the exhaust flow or aligning the at least one set of movable vanes with respect to the exhaust flow, respectively. Further embodiments of the Variable Geometry DEF Mixer utilizing at least one set of movable vanes may increase the angle of the at least one set of movable vanes within the mixer device under conditions of low exhaust flow, resulting in increased turbulence and thereby improving breakup of reductant droplets and mixing of the reductant with the exhaust. Further embodiments of the Variable Geometry DEF Mixer utilizing at least one set of movable vanes may decrease the angle of the at least one set of movable vanes within the mixer device under conditions of high exhaust flow, resulting in decreased turbulence, but also reducing exhaust flow restriction.

Further embodiments of the Variable Geometry DEF Mixer utilizing at least one set of movable vanes may use at least one set of upstream movable vanes and at least one set of downstream movable vanes, and may rotate the movable vanes of the upstream set and of the downstream set out of alignment with the exhaust flow in opposite directions under conditions of high exhaust flow, further increasing turbulence, reductant droplet breakup, and mixing of the reductant with the exhaust. The embodiments of the Variable Geometry DEF Mixer utilizing at least one set of upstream movable vanes and at least one set of downstream movable vanes may further rotate the movable vanes of the upstream set and of the downstream set into alignment with the exhaust flow under conditions of low exhaust flow, reducing turbulence, but also reducing exhaust flow restriction. Further embodiments of the Variable Geometry DEF Mixer using movable geometry defining components, such as movable mixer blades or movable vanes, may also be provided with at least one fixed geometry defining component, such as a fixed helical ramp or corkscrew, or other turbulence causing device.

According to one embodiment of the Variable Geometry DEF Mixer, a vehicle having an engine exhaust aftertreatment system includes a pipe for conducting a flow of exhaust. A mechanism is provided for introducing reductant into the flow of exhaust. A variable geometry mixer is located downstream from the mechanism for mixing the reductant with the flow of exhaust. A catalytic device is located downstream from the variable geometry mixer for causing the reductant to react with the flow of exhaust.

According to another embodiment of the Variable Geometry DEF Mixer, an engine exhaust aftertreatment system includes a pipe for conducting a flow of exhaust. A mechanism is provided for introducing reductant into the flow of exhaust. A variable geometry mixer is located downstream from the mechanism for mixing the reductant with the flow of exhaust. A catalytic device is located downstream from the variable geometry mixer for causing the reductant to react with the flow of exhaust.

According to another embodiment of the Variable Geometry DEF Mixer, a method for treating engine exhaust using a reductant includes several steps. The first step is introducing reductant into a flow of exhaust. The second step is mixing the reductant with the flow of exhaust using a variable geometry mixer having at least one movable geometry defining component connected to and actuated by at least one actuator. The third step is causing the reductant to react with the flow of exhaust using a catalytic device.

The Variable Geometry DEF Mixer has the ability to optimize reductant mixing in an exhaust stream over a wider range of exhaust flow rates. Components of the Variable Geometry DEF Mixer are robust and may be designed to last the entire lifetime of a vehicle.

### DESCRIPTION OF THE DRAWINGS

The above-mentioned and other features of embodiments of the Variable Geometry DEF Mixer, and the manner of their working, will become more apparent and will be better understood by reference to the following description of embodiments of the Variable Geometry DEF Mixer taken in conjunction with the accompanying drawings, wherein:

FIG. 1 is a top view of an embodiment of a Variable Geometry DEF Mixer, as described herein;

FIG. 2 is a sectional view of an embodiment thereof taken along line A-A of FIG. 1;

FIG. 3A is a side view of an embodiment of a movable mixer blade as utilized in FIG. 1;

FIG. 3B is an end view of an embodiment of a movable mixer blade as utilized in FIG. 1;

FIG. 3C is a bottom view of an embodiment of a movable mixer blade as utilized in FIG. 1;

FIG. 4 is a top view of an embodiment of a Variable Geometry DEF Mixer, as described herein;

FIG. 5 is a sectional view of an embodiment thereof taken along line B-B of FIG. 4;

FIG. 6 is a top view of an embodiment of a Variable Geometry DEF Mixer, as described herein; and

FIG. 7 is a sectional view of an embodiment thereof taken along line C-C of FIG. 6.

Corresponding reference numbers indicate corresponding parts throughout the several views. The exemplifications set out herein illustrate embodiments of the Variable Geometry DEF Mixer, and such exemplifications are not to be construed as limiting the scope of the claims in any manner.

### DETAILED DESCRIPTION

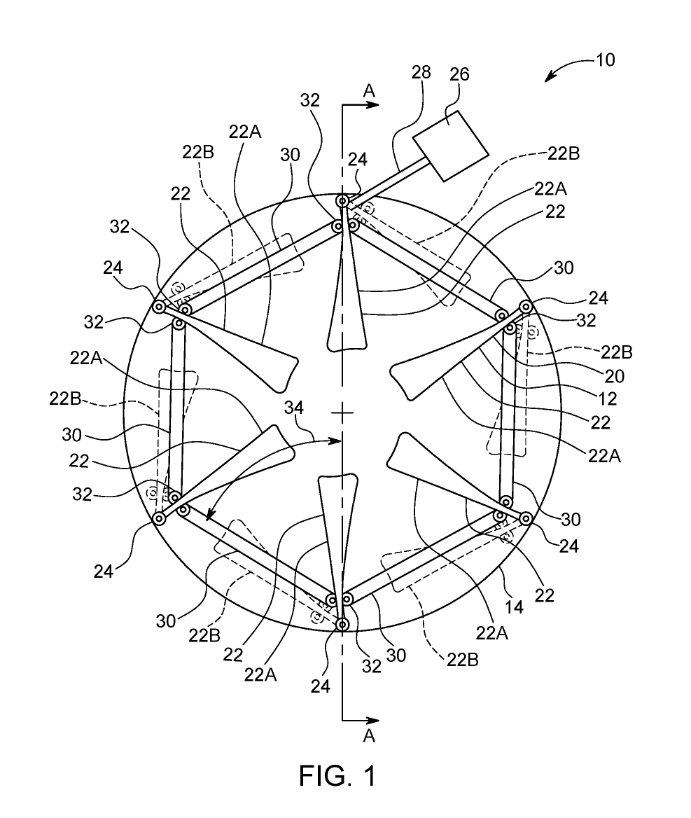

Referring now to FIGS. 1 and 2, a top view and a sectional view taken along line A-A, respectively, of an embodiment of a Variable Geometry DEF Mixer is shown. A DEF mixer 10 includes a mixing pipe 14 having within it a mixing device 12, which, in the embodiment shown in FIGS. 1 and 2, is a multiple blade mixer 20. Movable mixer blades 22 are connected to the mixing pipe 14 using mixer blade pivot points 24, which may be provided as vertical hinges as shown. A blade actuator 26 is connected to one of the movable mixer blades 22 by way of a blade actuator linkage 28 that passes through the wall of the mixing pipe 14. Angular movement of the movable mixer blades 22 is actuated and coordinated using an inter-blade linkage 30. Each of the links of the blade actuator linkage 28 and of the inter-blade linkage 30 is connected to the movable mixer blades 22 using a blade linkage connection 32.

The DEF mixer 10 uses the blade actuator 26 to increase or decrease the blade angle 34 of the movable mixer blades 22 within the mixing device 12, thereby extending the movable mixer blades 22 to extended position 22A, which is further into the exhaust flow 36, or retracting the movable mixer blades 22 to retracted position 22B, which is further out of the exhaust flow 36, respectively. The DEF mixer 10 may extend the movable mixer blades 22 to extended position 22A under conditions of low exhaust flow, resulting in increased swirl and rotation of the exhaust flow 36, thereby improving breakup of reductant droplets and mixing of the reductant with the exhaust. The DEF mixer 10 may retract the movable mixer blades 22 to retracted position 22B under conditions of high exhaust flow, resulting in decreased swirl and rotation of the exhaust flow 36, but also reducing exhaust flow restriction.

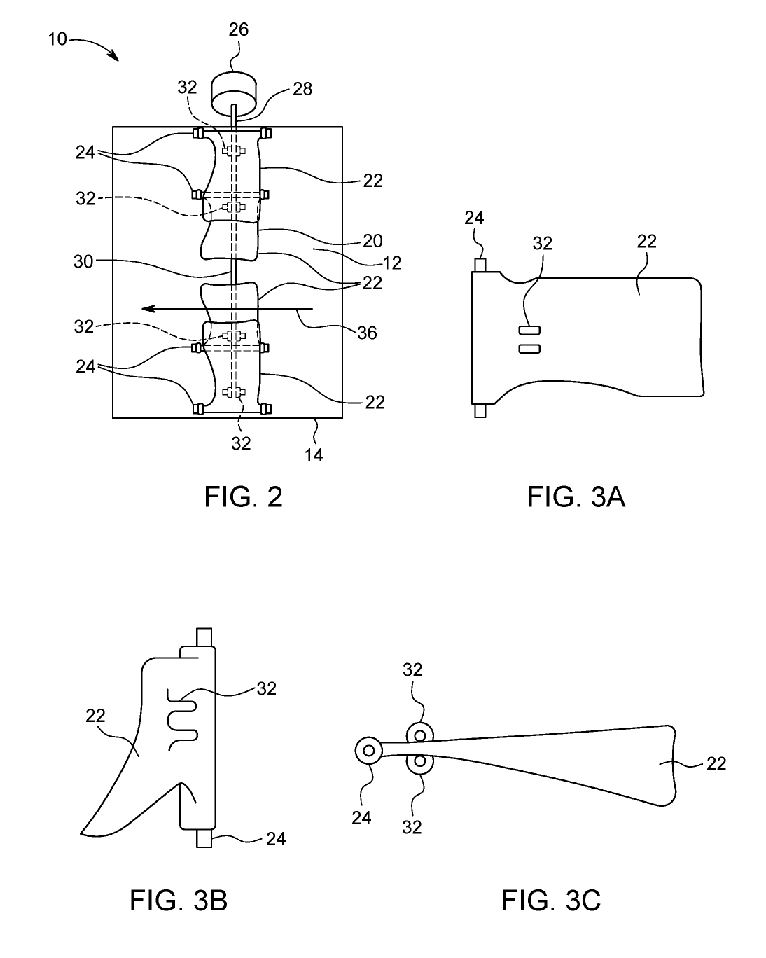

Turning now to FIGS. 3A, 3B, and 3C, a side view, an end view, and a bottom view, respectively, of an embodiment of a movable mixer blade 22 as utilized in FIGS. 1 and 2 is shown. The movable mixer blade 22 has mixer blade pivot points 24 in a vertical configuration, and is further provided with blade linkage connections 32 for connection with the links of the blade actuator linkage 28 and of the inter-blade linkage 30 (not shown).

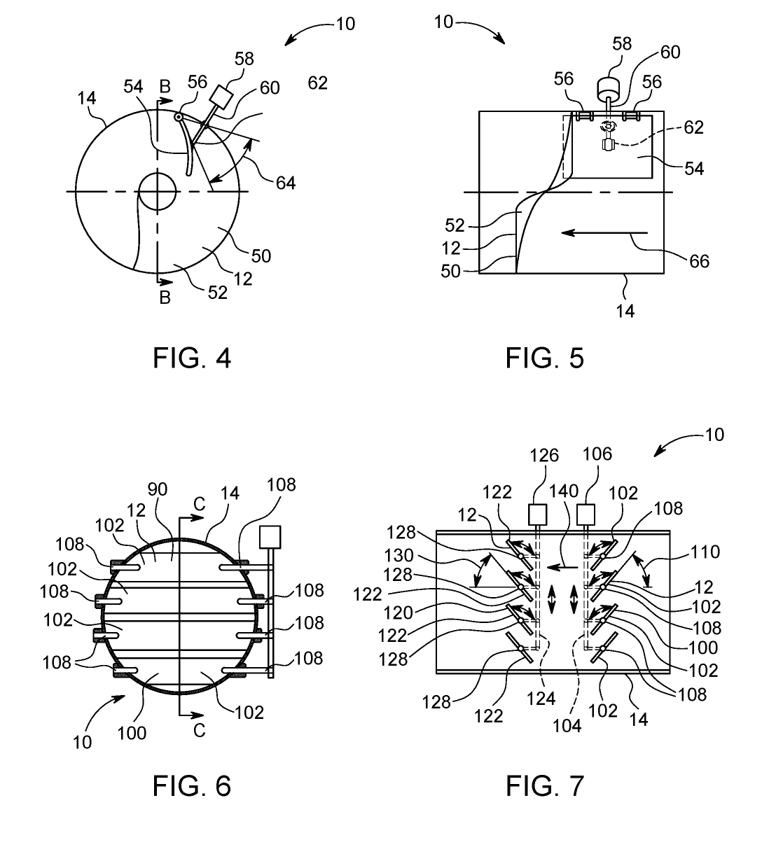

Referring now to FIGS. 4 and 5, a top view and a sectional view taken along line B-B, respectively, of an embodiment of a Variable Geometry DEF Mixer is shown. A DEF mixer 10 again includes a mixing pipe 14 having within it a mixing device 12, which, in the embodiment shown in FIGS. 4 and 5, is a helical ramp mixer 50. The mixing device 12 includes a fixed helical ramp or corkscrew 52 that induces rotation in the exhaust flow 66. At least one movable mixer blade 54 is connected to the mixing pipe 14 using at least one mixer blade pivot point 56, which may be provided as a vertical hinge as shown. The at least one movable mixer blade 54 adjoins or is proximate to the helical ramp mixer 50. A blade actuator 58 is connected to the at least one movable mixer blade 54 by way of a blade actuator linkage 60 that passes through the wall of the mixing pipe 14. The blade actuator linkage 60 is connected to the at least one movable mixer blade 54 using a blade linkage connection 62.

The DEF mixer 10 uses the blade actuator 58 to increase or decrease the blade angle 64 of the at least one movable mixer blade 54 within the mixing device, thereby extending the at least one movable mixer blade 54 as shown, or retracting the at least one movable mixer blade 54, respectively. The DEF mixer 10 may extend the at least one movable mixer blade 54 to the extended position shown under conditions of low exhaust flow, resulting in increased swirl, rotation, and turbulence of the exhaust flow 66, thereby improving breakup of reductant droplets and mixing of the reductant with the exhaust. The DEF mixer 10 may retract the at least one movable mixer blade 54 to a retracted position under conditions of high exhaust flow, resulting in decreased swirl, rotation, and turbulence of the exhaust flow 66, but also reducing exhaust flow restriction.

Turning now to FIGS. 6 and 7, a top view and a sectional view taken along line C-C, respectively, of an embodiment of a Variable Geometry DEF Mixer is shown. A DEF mixer 10 again includes a mixing pipe 14 having within it a mixing device 12, which, in the embodiment shown in FIGS. 6 and 6, is a movable vane mixer 90. The mixing device 12 includes an upstream vane assembly 100 having upstream movable vanes 102 and a downstream vane assembly 120 having downstream movable vanes 122. The upstream movable vanes 102 are pivotally connected to the mixing pipe 14 by way of upstream vane pivot points 108. An upstream vane actuator 106 acting through an upstream vane linkage 104 controls the upstream vane angle 110 of the upstream movable vanes 102. Similarly, the downstream movable vanes 122 are pivotally connected to the mixing pipe 14 by way of downstream vane pivot points 128. A downstream vane actuator 126 acting through a downstream vane linkage 124 controls the downstream vane angle 130 of the downstream movable vanes 122.

The movable vane mixer 90 uses the upstream vane actuator 106 and the downstream vane actuator 126 to increase or decrease the upstream vane angle 110 of the upstream movable vanes 102 and the downstream vane angle 130 of the downstream movable vanes 122, respectively. Increasing the upstream vane angle 110 of the upstream movable vanes 102 and the downstream vane angle 130 of the downstream movable vanes 122 skews the upstream movable vanes 102 and the downstream movable vanes 122 in opposite directions with respect to the exhaust flow 140. The movable vane mixer 90 may increase the upstream vane angle 110 of the upstream movable vanes 102 and the downstream vane angle 130 of the downstream movable vanes 122 under conditions of low exhaust flow 140, resulting in increased turbulence and thereby improving breakup of reductant droplets and mixing of the reductant with the exhaust. The movable vane mixer 90 may decrease the upstream vane angle 110 of the upstream movable vanes 102 and the downstream vane angle 130 of the downstream movable vanes 122 under conditions of high exhaust flow 140 resulting in decreased turbulence, but also reducing exhaust flow restriction.

While the Variable Geometry DEF Mixer has been described with respect to at least one embodiment, the Variable Geometry DEF Mixer can be further modified within the spirit and scope of this disclosure, as demonstrated previously. This application is therefore intended to cover any variations, uses, or adaptations of the Variable Geometry DEF Mixer using its general principles. Further, this application is intended to cover such departures from the present disclosure as come within known or customary practice in the art to which the disclosure pertains and which fall within the limits of the appended claims.

What is claimed is:

1. A vehicle having an engine exhaust aftertreatment system, comprising:
a pipe for conducting a flow of exhaust;
a mechanism for introducing reductant into the flow of exhaust;
a variable geometry mixer located downstream from the mechanism for mixing the reductant with the flow of exhaust; and
a catalytic device located downstream from the variable geometry mixer for causing the reductant to react with the flow of exhaust.

2. The vehicle of claim 1, wherein:
the variable geometry mixer has at least one movable geometry defining component connected to and actuated by at least one actuator; and
the at least one movable geometry defining component being adjustable by way of a change in at least one of an angle and a position.

3. The vehicle of claim 2, further comprising:
at least one fixed geometry defining component, the at least one movable geometry defining component adjoining the at least one fixed geometry defining component.

4. The vehicle of claim 2, wherein:
the at least one actuator being operable to adjust the at least one movable geometry defining component based upon at least one of:
exhaust flow conditions,
exhaust temperature,
reductant dosing quantity,
a current, pending, or recent particulate filter regeneration event,
vehicle information,
vehicle engine information,
vehicle location,
topographical information, and
environmental information.

5. The vehicle of claim 2, wherein:
the at least one movable geometry defining component further comprises at least one movable mixer blade; and
the at least one actuator being operable to extend the at least one movable mixer blade into the flow of exhaust under low exhaust flow conditions and to retract the at least one movable mixer blade out of the flow of exhaust under high exhaust flow conditions.

6. The vehicle of claim 5, wherein:
the pipe for conducting a flow of exhaust further comprises a mixer pipe;
the at least one movable mixer blade further comprises at least two movable mixer blades, each connected to the mixer pipe by way of at least one mixer blade pivot point;
the at least one actuator being connected to one of the at least two movable mixer blades by way of a mixer blade actuator linkage; and
the at least two movable mixer blades being connected by at least one inter-blade linkage.

7. The vehicle of claim 2, wherein:
the at least one movable geometry defining component further comprises at least one set of movable vanes;
the at least one actuator being operable to increase an angle of the at least one set of movable vanes under low exhaust flow conditions and to decrease the angle of the at least one set of movable vanes under high exhaust flow conditions.

8. The vehicle of claim 7, wherein:
the at least one set of movable vanes further comprises at least one set of upstream movable vanes and at least one set of downstream movable vanes; and
the at least one actuator further comprises at least one upstream actuator connected to the at least one set of upstream movable vanes by way of an upstream vane linkage and at least one downstream actuator connected to the at least one set of downstream movable vanes by way of a downstream vane linkage.

9. An engine exhaust aftertreatment system, comprising:
a pipe for conducting a flow of exhaust;
a mechanism for introducing reductant into the flow of exhaust;
a variable geometry mixer located downstream from the mechanism for mixing the reductant with the flow of exhaust; and
a catalytic device located downstream from the variable geometry mixer for causing the reductant to react with the flow of exhaust.

10. The engine exhaust aftertreatment system of claim 9, wherein:
the variable geometry mixer has at least one movable geometry defining component connected to and actuated by at least one actuator; and
the at least one movable geometry defining component being adjustable by way of a change in at least one of an angle and a position.

11. The engine exhaust aftertreatment system of claim 10, further comprising:
at least one fixed geometry defining component, the at least one movable geometry defining component adjoining the at least one fixed geometry defining component.

12. The engine exhaust aftertreatment system of claim 10, wherein:
the at least one actuator being operable to adjust the at least one movable geometry defining component based upon at least one of:
exhaust flow conditions,
exhaust temperature,
reductant dosing quantity,
a current, pending, or recent particulate filter regeneration event,
vehicle information,
vehicle engine information,
vehicle location,
topographical information, and
environmental information.

13. The engine exhaust aftertreatment system of claim 10, wherein:
the at least one movable geometry defining component further comprises at least one movable mixer blade; and
the at least one actuator being operable to extend the at least one movable mixer blade into the flow of exhaust under low exhaust flow conditions and to retract the at least one movable mixer blade out of the flow of exhaust under high exhaust flow conditions.

14. The engine exhaust aftertreatment system of claim 13, wherein:
the pipe for conducting a flow of exhaust further comprises a mixer pipe;
the at least one movable mixer blade further comprises at least two movable mixer blades, each connected to the mixer pipe by way of at least one mixer blade pivot point;
the at least one actuator being connected to one of the at least two movable mixer blades by way of a mixer blade actuator linkage; and
the at least two movable mixer blades being connected by at least one inter-blade linkage.

15. The engine exhaust aftertreatment system of claim 10, wherein:
the at least one movable geometry defining component further comprises at least one set of movable vanes;
the at least one actuator being operable to increase an angle of the at least one set of movable vanes under low exhaust flow conditions and to decrease the angle of the at least one set of movable vanes under high exhaust flow conditions.

16. The engine exhaust aftertreatment system of claim 15, wherein:
the at least one set of movable vanes further comprises at least one set of upstream movable vanes and at least one set of downstream movable vanes; and
the at least one actuator further comprises at least one upstream actuator connected to the at least one set of upstream movable vanes by way of an upstream vane linkage and at least one downstream actuator connected to the at least one set of downstream movable vanes by way of a downstream vane linkage.

17. A method for treating engine exhaust using a reductant, comprising the steps of:
introducing reductant into a flow of exhaust;
mixing the reductant with the flow of exhaust using a variable geometry mixer having at least one movable geometry defining component connected to and actuated by at least one actuator; and
causing the reductant to react with the flow of exhaust using a catalytic device.

18. The method of claim 17, further comprising the steps of:
adjusting the at least one movable geometry defining component using the at least one actuator based upon at least one of:
exhaust flow conditions,
exhaust temperature,
reductant dosing quantity,
a current, pending, or recent particulate filter regeneration event,
vehicle information,
vehicle engine information,
vehicle location,
topographical information, and
environmental information.

19. The method of claim 17, further comprising the steps of:
providing the at least one movable geometry defining component in the form of at least one movable mixer blade; and
using the at least one actuator to extend the at least one movable mixer blade into the flow of exhaust under low exhaust flow conditions and to retract the at least one movable mixer blade out of the flow of exhaust under high exhaust flow conditions.

20. The method of claim 17, further comprising the steps of:
providing the at least one movable geometry defining component in the form of at least one set of movable vanes;
using the at least one actuator to increase an angle of the at least one set of movable vanes under low exhaust flow conditions and to decrease the angle of the at least one set of movable vanes under high exhaust flow conditions.
